(19) United States
(12) Patent Application Publication
(10) Pub. No.: US 2009/0154382 A1
(43) Pub. Date: Jun. 18, 2009

(54) MEDIUM ACCESS CONTROL DEVICE FOR PROCESSING DATA AT HIGH SPEED AND METHOD THEREOF

(75) Inventors: Hyun-Gu PARK, Seoul (KR); Yoo-Seung SONG, Daejon (KR); Jee-Yon CHOI, Daejon (KR); Yun-Joo KIM, Suwon-si (KR); Kyoung-Hee SONG, Jeonju-si (KR); Sok-Lyu LEE, Daejon (KR)

Correspondence Address: Muncy, Geissler, Olds & Lowe, PLLC, P.O. BOX 1364, FAIRFAX, VA, 22038-1364, US

(73) Assignee: Electronics and Telecommunications Research Institute, Daejon (KR)

(21) Appl. No.: 12/128,152

(22) Filed: May 28, 2008

(30) Foreign Application Priority Data
Dec. 15, 2007 (KR) 10-2007-0131834

(51) Int. Cl. H04Q 7/00; H04L 29/02

(52) U.S. Cl. 370/310; 370/476

(57) ABSTRACT

Provide are a medium access control MAC device for processing data at a high speed and a method thereof. The MAC device includes a packet receiving and processing unit for receiving packet data transmitted from a physical layer device and extracting data and data information from the received packet data by processing the received packet data; a data multiprocessing unit for sequentially multiplexing the extracted data and storing the extracted data in a first memory; and a data arranging unit for arranging the stored data in sequence number order using addresses of the first memory and the extracted data information, and transmitting the arranged data to an upper layer interface.

### BACKGROUND OF THE INVENTION

1. Field of the Invention

The present invention relates to a medium access control MAC device for processing data at a high speed and a method thereof; and, more particularly, to a MAC device for receiving and processing packet data at a high speed and simultaneously processing a plurality of packet data from multiple antennas by sequentially storing data in a data memory, storing data information in another memory in memory address order corresponding to data sequence number order, and reading the data corresponding to the data information stored in the memory address order, and a method thereof.

This work was supported by the IT R&D program of MIC/IITA [2006-S-002-02, “IMT-Advanced Radio Transmission Technology with Low Mobility”].

2. Description of Related Art

In a wireless transmission system, a medium access control (MAC) device receives data packets through a physical layer (PHY) and a PHY-MAC interface and checks validity of the received data packets. A MAC device in a transmitting side calculates a cyclic code through cyclic redundancy check (CRC) for data to be transmitted and transmits the calculated cyclic code with the data. A MAC device in a receiving side determines the validity of received data packets by calculating CRC of the received data packets and comparing the calculated CRC with the cyclic code in the received data packets.

After checking validity, the MAC device in the receiving side compares a destination address of the received data packet with an address assigned to itself only for the valid data. If the destination address of the received data is different from the assigned address, the MAC device obtains necessary information from the received data packet and discards the received data packet. Here, the information, which can be obtained by the MAC device, may vary according to a MAC protocol. For example, the MAC device generally obtains an address of a device that sends the data packet, a modulation scheme, and a signal to noise ratio (SNR). Here, the SNR is valued valid information because the SNR may be used to determine a channel state.

If the destination address is equal to an address of receiving equipment, the MAC device in the receiving side analyzes a header in the received data packet and processes the received data packet according to a related protocol. In general, such data packet includes control data and data. The data includes a header including attribute of data. That is, a bundle of a header, data, and CRC is defined as a packet.

For example, an acknowledgement (Ack) packet is one of representative examples of a control packet. The Ack packet is acknowledgment informing that a receiving side successfully receives data. Since a header of the Ack packet includes a flag and a predetermined value that informs of an Ack packet, the MAC device can identify an Ack packet based on the header. Also, the header of the Ack packet may include a signal-to-noise ratio (SNR) measured when a normal data is received, not control data. There was a method introduced for selecting a modulation scheme according to the SNR of a receiving side.

Meanwhile, a transmitter generally divides data by a predetermined size and transmits the divided data in order to effectively use a bandwidth necessary for restoring original data when a packet is lost. Due to the characteristics of a wireless channel, packets may be frequently lost. Particularly, this method is more effective if errors are frequently generated due to an instable state of a wireless channel because this method wastes less bandwidth for restoring packets from errors.

However, this method may be ineffective because a header and CRC information attached to all of divided packets become overhead if errors are not frequently generated because a wireless channel has a stable channel condition. Therefore, a transmitter calculates the optimal size for dividing a packet according to the channel state and divides and transmits the data according to the calculated optimal size. Due to such a method of dividing and transmitting data, the receiving side needs an algorithm for arranging packets that were divided and transmitted from the transmitter.

In a typical wireless transmission system, a MAC device supports about 11 Mpbs as a maximum data receiving rate for 802.11b, about 54 Mbps as a maximum data receiving rate for 802.11a and about 270 Mbps as a maximum data receiving rate for 802.11n. Therefore, a MAC device was designed to receive data at the maximum speed of 270 Mbps.

However, the MAC device was designed without internal data flow considered. The MAC device cannot stably receive data without errors if the MAC device receives data from a physical layer at a minimum speed of about 3.63 Gbps. Also, the MAC device cannot satisfy the data processing requirements of a fourth generation wireless transmission system.

Since the fourth generation wireless transmission system supports a data transmit rate of about Giga bits per second level, a MAC device must have a structure for smoothly controlling data flow and an effective algorithm for receiving and processing data at a data receiving rate of Giga bits per second level without errors.

### SUMMARY OF THE INVENTION

An embodiment of the present invention is directed to providing a medium access control (MAC) device for receiving and processing a plurality of data packets received through multiple antennas at a predetermined speed higher than a Giga bits per second (Gpbs) level.

Another embodiment of the present invention is directed to providing a MAC device for receiving and processing packet data at a high speed and simultaneously processing a plurality of packet data from multiple antennas by sequentially storing data in a data memory, storing data information in another memory in memory address order corresponding to data sequence number order, and reading the data corresponding to the data information stored in the memory address order, and a method thereof.

In accordance with an aspect of the present invention, there is provided a medium access control (MAC) device for processing data including a packet receiving and processing unit for receiving packet data transmitted from a physical layer device and extracting data and data information from the received packet data by processing the received packet data; a data multiprocessing unit for sequentially multiplexing the extracted data and storing the extracted data in a first memory; and a data arranging unit for arranging the stored data in sequence number order using addresses of the first memory and the extracted data information, and transmitting the arranged data to an upper layer interface.

In accordance with another aspect of the present invention, there is provided a medium access control (MAC) method for processing data at a high speed, including receiving packet data transmitted from a physical layer device and extracting data and data information from the received packet data by processing the received packet data; sequentially multiplexing the extracted data and storing the extracted data in a first memory; and arranging the stored data in sequence number order using addresses of the first memory and the extracted data information, and transmitting the arranged data to an upper layer interface.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

### BRIEF DESCRIPTION OF THE DRAWINGS

FIG. 1 is a diagram illustrating a medium access control (MAC) device for receiving and processing data at a high speed in accordance with an embodiment of the present invention.

FIG. 2 is a diagram illustrating the step of arranging data, which is performed by a data arranging unit of FIG. 1.

FIG. 3 is a flowchart illustrating a medium access control (MAC) method for processing data at a high speed in accordance with an embodiment of the present invention.

### DESCRIPTION OF SPECIFIC EMBODIMENTS

The advantages, features and aspects of the invention will become apparent from the following description of the embodiments with reference to the accompanying drawings, which is set forth hereinafter.

The present invention relates to design for receiving and processing data at a high speed. Particularly, the present invention relates to a medium access control (MAC) device that can provide stable performance in a fourth generation wireless transmission system supporting a data transmit rate of about Giga bits per second (Gbps).

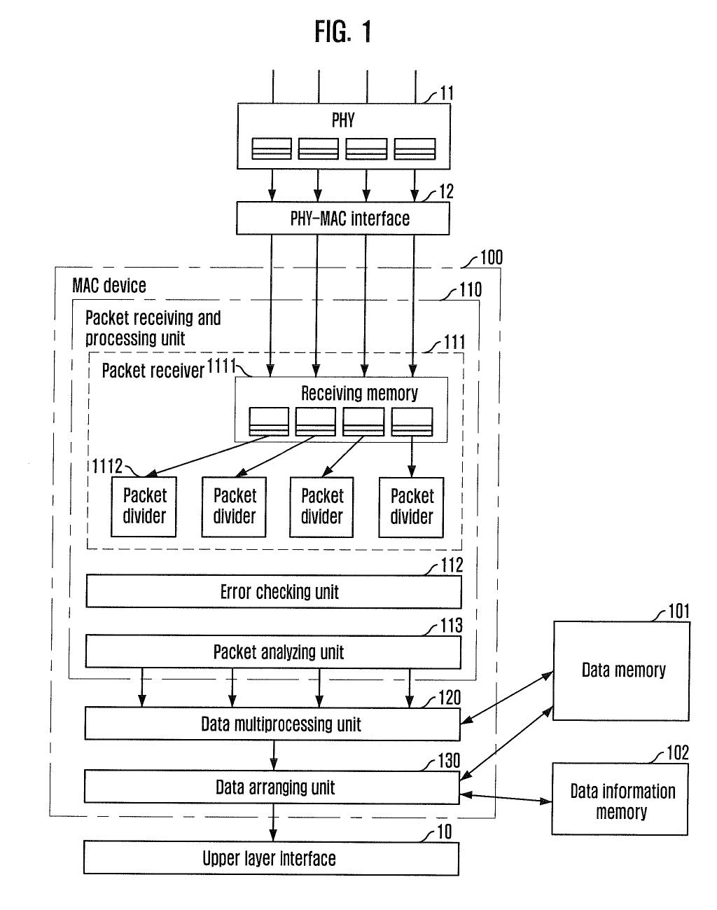

FIG. 1 is a diagram illustrating a medium access control (MAC) device for receiving and processing data at a high speed in accordance with an embodiment of the present invention.

Referring to FIG. 1, the MAC device 100 according to the present embodiment includes a packet receiving and processing unit 110, a data multiprocessing unit 120, and a data arranging unit 130. The packet receiving and processing unit 110 includes a packet receiver 111, an error checking unit 112, and a packet analyzing unit 113. Also, the packet receiver 111 includes a receiving memory 1111 and a packet divider 1112.

The packet receiving and processing unit 110 performs a receiving preparation process when a physical layer 11 (PHY) informs the packet receiving and processing unit 110 of packet arrival. As the receiving preparation process, the packet receiving and processing unit 110 initializes states of a finite state machine therein and initializes temporal memory areas. Such a receiving preparation process is performed whenever the packet receiving and processing unit starts receiving packets. Although the packet receiving and processing unit 110 becomes unstable and transits to an unexpected abnormal state, the receiving preparation process makes the packet receiving and processing unit 110 to return to a stable state again at a next receiving processing starting state.

The packet receiving and processing unit 110 checks an error of packet data and transfers the result of analyzing the packet data with the data to the data multiprocessing unit 120. Hereinafter, constituent elements of the packet receiving and processing unit 110 will be described.

After the receiving preparation process, the packet receiver 111 receives packet data from a physical layer device 11 through the PHY-MAC interface 12. Here, the packet receiver 111 identifies the received packet data by multiple antennas. The packet receiver 111 stores the received packet data in the receiving memory 111. The receiving memory 1111 has a structure divided by multiple antennas.

If the packet divider 1112 senses that packet data is stored in the receiving memory 1111, the packet divider 1112 reads the stored packet data and divides the read data by a predetermined data processing unit.

Since the MAC device according to the present invention is designed for the fourth generation wireless transmission system which supports a data transmit rate of Gbps level, there is a large probability of losing packets if data processing is delayed in the packet receiving and processing unit 110. In consideration of data loss, the packet divider 1112 of the packet receiver 111 performs a predetermined operation for preventing data from losing by not allowing data to be read from the receiving memory 1111. Also, the receiving memory 1111 performs a buffering function for data transferred from the physical layer device 11.

The error checking unit 112 reads header information at a beginning part of packet data divided by a data processing unit and determines the validity of a header by analyzing CRC of a header. The MAC device continuously processes data packet only if the error checking unit 112 determines that the header is a header of a valid packet data.

Only for the packet data having the valid header, the packet analyzing unit 113 determines whether the received packet is a data packet that requires a comparatively fast process speed or a control packet that requires a comparatively slow process speed. After determination, the packet analyzing unit processes the packet at a high speed if the received packet is the data packet. If the received packet is the control packet, the packet analyzing unit determines and classifies a type of the control packet and outputs a related signal to a control packet processor (not shown). That is, the packet analyzing unit performs different operations according to whether the received packet is the data packet or the control packet.

In more detail, the packet analyzing unit analyzes and extracts transmission information from the control packet and outputs the extracted transmission information to a transmitting end because the control packet generally includes the transmission information used for next transmission.

On the contrary, if the packet data is the data packet, the packet analyzing unit 113 compares an error checking result of the error checking unit 112 with a CRC result attached at the end of the data packet as long as a length of data in a header. The packet analyzing unit 113 determines that the data packet is valid only if the error checking result is equal to the CRC result. The packet analyzing unit 113 stores valid data in a memory. The packet analyzing unit 113 generates an Ack packet using the error checking result and transfers the Ack packet to the transmitting end.

Among the results of analyzing packet data, the packet analyzing unit transfers data division information for identifying data by each of multiple antennas and data sequence number information by each of multiple antennas to the data arranging unit 130 through the data multiprocessing unit 120.

The MAC device 100 according to the present embodiment may receive packets from multiple antennas at the same time if the MAC device 100 is used for a wireless transmission system using multiple antennas. For example, if the MAC device 100 receives N different independent packets at the same time, the MAC device 100 can process the received N different independent packets at the same time through N packet receivers 111 having N receiving memories 1111 and N packet dividers 1112, an error checking unit 112, and a packet analyzing unit.

The data multiprocessing unit 120 multiplexes data of each of multiple antennas, which is determined as valid by the packet analyzing unit, regardless of antennas, and stores the multiplexed data in the data memory 101 in data transfer order. Here, data storing order of the data memory 101 may be different from the data transfer order. It is because data is received through different multiple antennas. If different modulation schemes or coding schemes are used by multiple antennas, a data transmit rate of a transmitting side may become different. The data multiprocessing unit 120 sequentially transfers memory address information stored in the data memory 101 to the data arranging unit 130.

The data arranging unit 130 generates a descriptor using memory address information transferred from the data multiprocessing unit 120 and data information having the data division information and data sequence number transferred from the data receiving and processing unit 110. Then, the data arranging unit 130 stores the descriptor in another memory which is different from the data memory storing the data, such as the data information memory 120. The data arranging unit 130 arranges data that is randomly stored in the data memory 101 in data sequence number order and transfers the arranged data to the upper layer interface 10. Here, the data sequence number is a sequence number assigned to packet data.

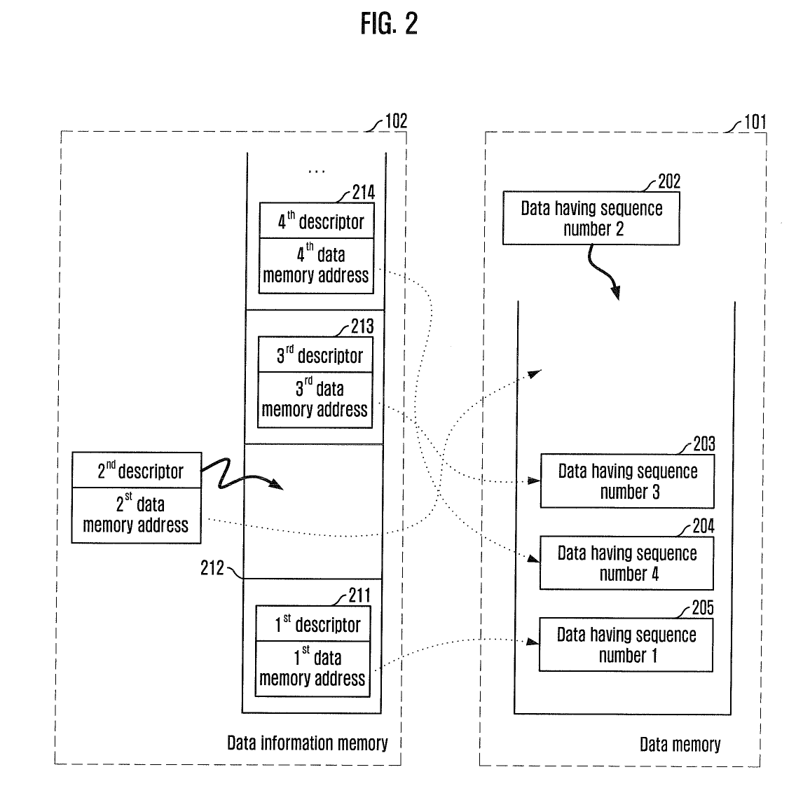

FIG. 2 is a diagram illustrating the step of arranging data, which is performed by a data arranging unit of FIG. 1.

The data multiprocessing unit 120 multiplexes a plurality of data of multiple antennas, which are randomly transferred from the packet receiving and processing unit 110, and sequentially stores the multiplexed data into the data memory 101.

Here, the data arranging unit 130 stores the descriptors at predetermined addresses of the data information memory 102 corresponding to sequence numbers of the data thereof. That is, the data arranging unit 130 maps address order of the data information memory 102 to data sequence number order of the data. Then, the data information memory 102 stores descriptors and memory addresses of the data memory 101 for each data together in the data sequence number order.

After storing the descriptors of each data at the data information memory 102 in the data sequence number order, the data arranging unit 130 reads the data information memory 102 storing the descriptors in memory address order from the beginning thereof. The data arranging unit 130 can access data in the data sequence number order if the data arranging unit 130 access a memory address of the data memory, which is recorded in each of the descriptors. Therefore, the data arranging unit 120 can effectively arrange data by reducing a time for arranging the data.

The step of arranging data will be described under an assumption that the data multiprocessing unit 120 sequentially receives first data 201 having a sequence number 1, fourth data 204 having a sequence number 4, third data 203 having a sequence number 3, and second data 202 having a sequence number 2.

The data multiprocessing unit 120 sequentially stores the first data 201 with the sequence number 1, the fourth data 204 with the sequence number 4, the third data 203 with the sequence number 3, and the second data 202 with the sequence number 2 in the data memory 101 in data receiving order. Here, the data arranging unit 130 stores descriptors and memory address of the received data 201, 204, 203, and 202 at predetermined addresses of the data information memory 201 corresponding to data sequence number of each data. Here, the memory address denotes an address of the data memory 101.

For example, the data multiprocessing unit 120 stores the second data 202 having the sequence number 2 at a fourth memory address of the data memory 101. Then, the data arranging unit 130 stores the second descriptor at a second address 212 of the data information memory 102, which is corresponding to the data sequence number of the second data 202. Equivalently, a first descriptor is stored at a first address 211 of the data information memory 120 with the memory address of the first data 201, a third descriptor is stored at a third address 213 of the data information memory 102 with the memory address of the third data 203, and a fourth descriptor is stored at a fourth address 214 of the data information memory 102 with the memory address of the fourth data 204.

After storing, the data arranging unit 130 can fetch data from the data memory 101 in the data sequence number order of the first to fourth data 201 to 204 if the data arranging unit 130 sequentially accesses the data information memory 102. Therefore, it is possible to reduce a time for arranging data compared to the related art.

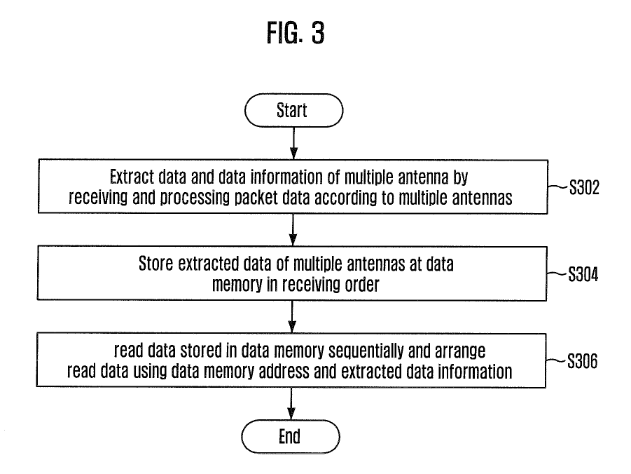

FIG. 3 is a flowchart illustrating a medium access control (MAC) method for processing data at a high speed in accordance with an embodiment of the present invention.

Referring to FIG. 3, the packet receiving and processing unit 110 receives a plurality of packet data from multiple antennas and extracts data and data information from the received packet data by processing the received packet data at step S302.

At step S304, the data multiprocessing unit 120 multiplexes the valid data of each antenna, which is determined at the packet analyzing unit, regardless of antennas and stores the multiplexed data at the data memory 101 in data receiving order.

At step S306, the data arranging unit 130 generates descriptors using memory address information transferred from the data multiprocessing unit 120 and data information including data division information and data sequence numbers transferred from the data receiving processor 110. Then, the data arranging unit 130 stores the generated descriptors in another memory which is different from the data memory 101 storing the data information, such as the data information memory 102, in data sequence number order. The data arranging unit 130 arranges a plurality of data, which are randomly stored in the data memory 101, in order of data sequence numbers which are assigned to packet data and transfers it to an upper layer interface 10.

The above described method according to the present invention can be embodied as a program and stored on a computer readable recording medium. The computer readable recording medium is any data storage device that can store data which can be thereafter read by the computer system. The computer readable recording medium includes a read-only memory (ROM), a random-access memory (RAM), a CD-ROM, a floppy disk, a hard disk and an optical magnetic disk.

As described above, the medium access control (MAC) device according to the present invention can process data at high speed by sequentially storing data in a data memory, sequentially storing data information in order of memory addresses corresponding to order of data sequence numbers in another memory, and reading data corresponding to stored data information in order of memory addresses.

Furthermore, the MAC device according to the present invention can receive and process a plurality of packet data of multiple antennas at the same time. The MAC device according to the present invention may be applied to a multiple antenna wireless transmission system supporting a data transmit rate of minimum 3.6 Gbps.

Moreover, the MAC device according to the present invention is designed to receive and process data at a high speed. Therefore, the MAC device according to the present invention can be applied to a wireless transmission system that requires high speed data processing.

The present application contains subject matter related to Korean Patent Application No. 10-2007-0131834, filed in the Korean Intellectual Property Office on Dec. 15, 2007, the entire contents of which is incorporated herein by reference.

While the present invention has been described with respect to the specific embodiments, it will be apparent to those skilled in the art that various changes and modifications may be made without departing from the spirit and scope of the invention as defined in the following claims.

What is claimed is:

1. A medium access control (MAC) device for receiving and processing data at a high speed, comprising:
a packet receiving and processing means for receiving packet data transmitted from a physical layer device and extracting data and data information from the received packet data by processing the received packet data;
a data multiprocessing means for sequentially multiplexing the extracted data and storing the extracted data in a first memory; and
a data arranging means for arranging the stored data in sequence number order using addresses of the first memory and the extracted data information, and transmitting the arranged data to an upper layer interface.

2. The MAC device of claim 1, wherein the data arranging means stores the extracted data information and corresponding addresses of the first memory in a second memory in order of data sequence number, and reads and arranges data from addresses of the first memory in order of the data sequence numbers of the second memory.

3. The MAC device of claim 2, wherein the data arranging means stores the data information in the second memory using a descriptor.

4. The MAC device of claim 2, wherein the packet receiving and processing means receives and processes a plurality of packet data, which are independently received through multiple antennas, from the physical layer device.

5. The MAC device of claim 4, wherein the packet receiving and processing means includes:
a packet receiving means for receiving packet data of each multiple antenna transferred from the physical layer device, and dividing the received packet data by a predetermined unit for multiple access control;
an error checking means for checking an error of the divided packet data; and
a packet analyzing means for extracting data of each multiple antenna and data information for the data by analyzing a header of the packet data.

6. The MAC device of claim 5, wherein the packet receiving means includes a receiving memory and buffers data of each multiple antenna transferred from the physical layer device using the receiving memory.

7. A medium access control (MAC) method for processing data at a high speed, comprising:
receiving packet data transmitted from a physical layer device and extracting data and data information from the received packet data by processing the received packet data;
sequentially multiplexing the extracted data and storing the extracted data in a first memory; and
arranging the stored data in sequence number order using addresses of the first memory and the extracted data information, and transmitting the arranged data to an upper layer interface.

8. The method of claim 7, wherein in said arranging the stored data in sequence number order, the extracted data information and corresponding addresses of the first memory are stored in a second memory in order of data sequence number, data are read from addresses of the first memory in order of the data sequence numbers of the second memory, and the read data are arranged.

9. The method of claim 8, wherein in said arranging the stored data in sequence number order, the data information is stored in the second memory using a descriptor.

10. The method of claim 8, wherein in said receiving packet data, a plurality of packet data independently received through multiple antennas are received from the physical layer device and processed.

11. The method of claim 10, wherein said receiving packet data includes:
receiving packet data of each multiple antenna transferred from the physical layer device, and dividing the received packet data by a predetermined unit for multiple access control;
checking an error of the divided packet data; and
extracting data of each multiple antenna and data information for the data by analyzing a header of the packet data.
